(19) United States
(12) Patent Application Publication
(10) Pub. No.: US 2023/0363970 A1
(43) Pub. Date: Nov. 16, 2023

(54) SPINE PIANO

(71) Applicant: Adal Bermann, San Diego, CA (US)

(72) Inventor: Adal Bermann, San Diego, CA (US)

(21) Appl. No.: 17/744,039

(22) Filed: May 13, 2022

(51) Int. Cl. A61H 1/00

(52) U.S. Cl. CPC A61H 1/008; A61H 2201/0142; A61H 2201/1604; A61H 2201/164; A61H 2201/1645; A61H 2201/1664; A61H 2201/5041

(57) ABSTRACT

Apparatus, systems and methods for adjusting a person’s spine comprising multiple surfaces each configured to move relative to the person’s spine to change a curvature of the person’s spine. The at least two surfaces are configured to change the relative positions of at least two vertebrates in the person’s spine, for example, pushing into at least a portion of the person’s spine, such that the person’s spine is in a backward bending or forward bending position.

### BACKGROUND

Proper alignment of the spine is critical to the health of the skeletal system and the spinal cord, the information superhighway of the central nervous system. Unfortunately, many people such as those having desk-jobs often have improper posture and work ergonomics, leading to improper spine alignment after prolonged sitting or work. Stretching can be an effective way to alleviate some of the symptoms but can be less effective when performed alone without support and assistance.

### SUMMARY

Disclosed herein are apparatus, systems and methods in which a person’s spine is adjusted to restore proper alignment, increase flexibility, and to create a supportive and pleasurable sensation during stretching of the spine. In some aspects, the disclosure provides a device comprising a support configured to support the person’s spine, wherein the support comprises at least two surfaces, and wherein the at least two surfaces are each configured to move relative to the person’s spine to change a curvature of the person’s spine. In some cases, the at least two surfaces are configured to change the relative positions of at least two vertebrates in the person’s spine. In some cases, the at least two surfaces are each configured to push into at least a portion of the person’s spine.

In some instances, the at least two surfaces are each configured to move relatively perpendicular to the curvature of the person’s spine. In some instances, the at least two surfaces are configured to move independently relative to each other. In some instances, the at least two surfaces are configured to move simultaneously. In some instances, the at least two surfaces are configured to move sequentially. In some instances, the at least two surfaces are configured to move vertically relative to each other.

In some cases, the support comprises at least three surfaces each configured to move relative to the person’s spine to change a curvature of the person’s spine. In some cases, the support comprises at least four surfaces each configured to move relative to the person’s spine to change a curvature of the person’s spine. In some instances, the support comprises at least five surfaces each configured to move relative to the person’s spine to change a curvature of the person’s spine. In some instances, the support comprises at least six surfaces each configured to move relative to the person’s spine to change a curvature of the person’s spine. In some instances, each surface is configured to move relatively perpendicular to the curvature of the person’s spine. In some instances, each surface is configured to move independently relative to each other.

In some instances, the change in the curvature of the person’s spine comprising forward bending of the spine. In some instances, the change in the curvature of the person’s spine comprises backward bending of the spine.

In some aspects, the devices disclosed herein further comprise at least one actuator configured to move at least one surface. In some cases, the actuator comprises at least one of a motor, a piston, a liquid pump, or an air pump. In some cases, the actuator comprises a handle configured to be operated by a human.

In some aspects, the devices disclosed herein further comprise a controller, wherein at least one surface is controlled by the controller. In some cases, each surface is controlled by the controller. In some cases the controller is configured to be operated by the person.

In some aspects, the devices disclosed herein further comprise a leg support for the person’s legs. In some aspects, the devices disclosed herein further comprise a head support for the person’s head. In some aspects, at least one surface comprises two protrusions configured to contact the left and right side of the spine. In some aspects, at least one surface is configured to contact the person’s upper back; and at least one surface is configured to contact the person’s lower back.

Some aspects of the disclosure provide a device comprising a device for adjusting a person’s spine, comprising a support configured to support the person’s spine, wherein the support comprises a surface configured to change shape and to change a curvature of the person’s spine. In some cases, the changing shape of the surface is configured to change the relative positions of at least two vertebrates in the person’s spine.

In some cases, the changing shape of the surface is configured to push into at least a portion of the person’s back. In some cases, the change in the curvature of the person’s spine may include forward bending of the person’s spine. In some cases, the change in the curvature of the person’s spine may include backward bending of the person’s spine.

Some aspects of the disclosure provide methods of adjusting a person’s spine using the devices disclosed herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A shows a side view of a non-limiting example of a Spine Piano having linear motion actuators in a starting position.

FIG. 1B shows a side view of the Spine Piano in FIG. 1A in a working position to adjust a person’s spine.

FIG. 1C shows a non-limiting example of a control panel having analog sliders that can be used to control the Spine Piano in FIG. 1A.

FIG. 1D shows a non-limiting example of a control panel having digital slider that can be used to control the Spine Piano in FIG. 1A.

FIG. 2A shows a side view of a non-limiting example of a Spine Piano having inflatable chambers, a compressor and valves, in a starting position.

FIG. 2B shows a side view of the Spine Piano in FIG. 2A in a working position to adjust a person’s spine.

FIG. 3 shows cross-sectional view of possible examples of protrusions having different shapes that make contact with a person.

FIG. 4 shows a side view of a non-limiting example of a Spine Piano having pistons on wheels on shaped track in a working position to adjust a person’s spine.

FIG. 5A shows a side view of a non-limiting example of a Spine Piano having electrical actuator switches in a working position to adjust a person’s spine.

FIG. 5B shows a non-limiting example of a joystick type control mechanism.

FIG. 5C shows a non-limiting example of a thumbwheel type control mechanism.

### DETAILED DESCRIPTION

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As used herein, the term “similar” means two shapes having corresponding sides proportional and corresponding angles equal. Moreover, if minor changes are made to one or both shapes, they are considered substantially similar to each other. For example, a larger triangle with three equal sides is similar to a smaller triangle with three equal sides. If the smaller triangle has one or more corners beveled, it is substantially similar to the larger triangle.

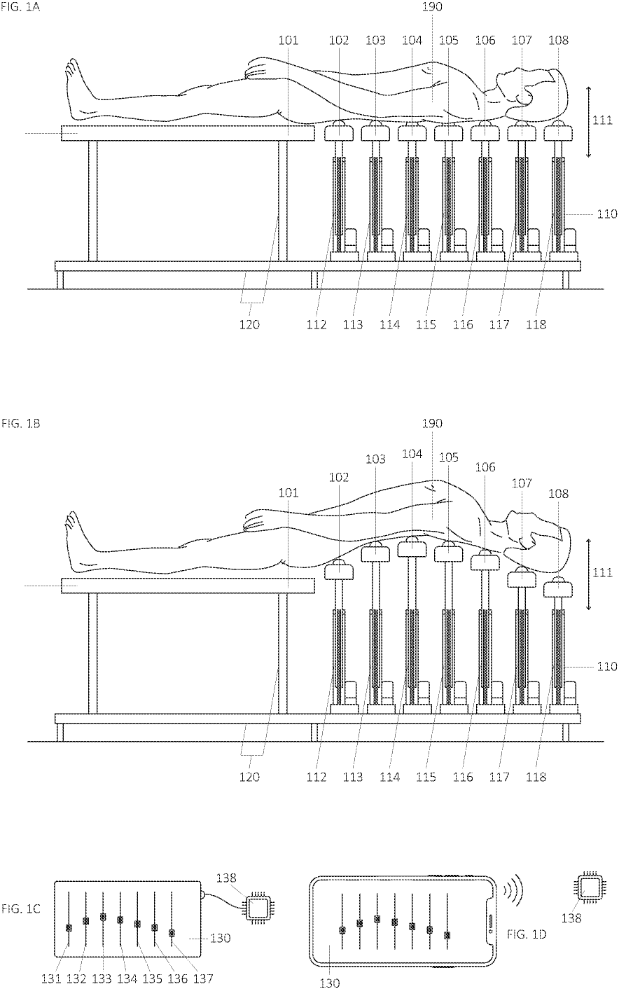

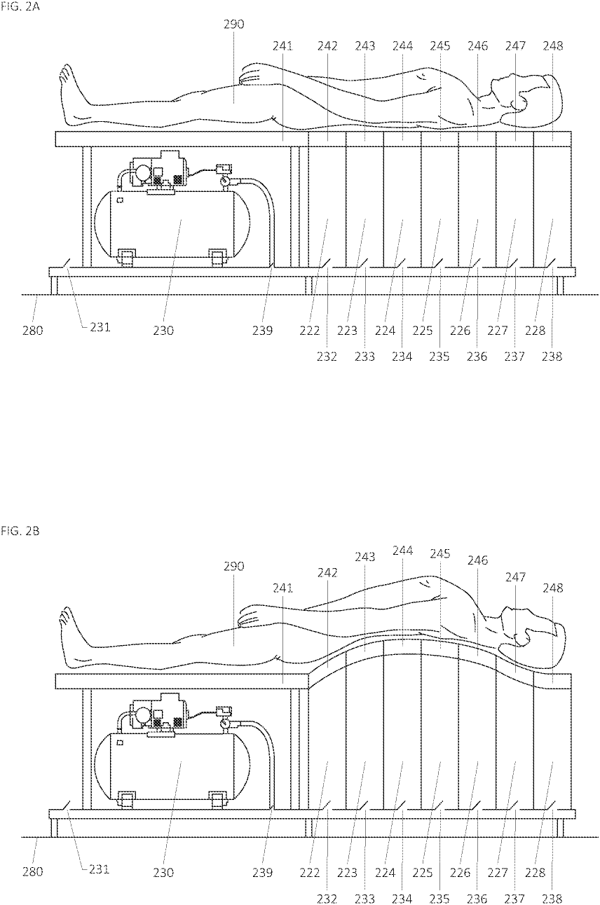

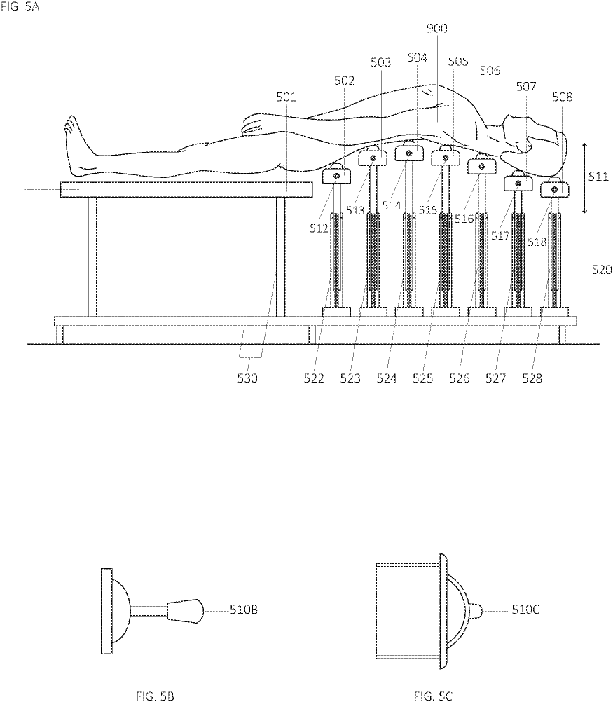

FIG. 1A shows a side view of the relative position between a Spine Piano (100) and a person (190) laying on top of it. In this example, the Spine Piano (100) has a mechanical set (110), a top surface (101) supporting the person’s legs, multiple top surfaces (102-105) supporting the person’s back, a top surface 106 supporting the person’s neck, and top surfaces 107 and 108 supporting the person’s head. The multiple surfaces (102-108) are each configured to move up and down vertically (along directions shown by arrow 111) to change the curvature of the person’s spine. The multiple top surfaces (102-105) can be moved up and down using multiple motion actuators (112-118). In some cases, the multiple motion actuators (112-118) are linear motion actuators. Each of two or more surfaces (102-108) are attached to their own individual motion actuators (112-118). The motion actuators are coupled to a control interface, for example a control panel (shown in FIG. 1C and FIG. 1D) or as another example individual control switches (shown in FIG. 5A and FIG. 5B and FIG. 5C). In FIG. 1B, the multiple surfaces (102-108) are positioned to push into the person’s back, creating a backward bending curvature in the spine (i.e., the middle portion of the person’s spine is pushed upwards, while the persons’ lower back and neck are lower than the middle portion).

FIG. 1C and FIG. 1D shows examples of a contemplated control panel that can be used to control the vertical movement of the multiple surfaces (102-108). FIG. 1C shows an analog version of the control panel in which the sliders can be moved mechanically, for example, by a person’s hand. FIG. 1D shows a digital version of the control panel, such as an application (“app”) on a mobile device, in which representations of sliders are displayed on a tactile touch screen and can be adjusted with touch and motion (e.g., finger motion). The control panel can be made of sliders (131-137) that model at a smaller scale the layout and range of motion of the set of motion actuators (112-118). The control panel has a processor (138) that interprets the input from the control panel and sends signal to the motion actuating mechanics to initiate movement of the multiple surfaces (102-108). When a slider (133) is moved to a new position, the control panel will activate the corresponding motion actuator (114) so that it moves its attached section of the top surface (104) to a specific vertical coordinate that is calculated proportionally to the new position of that slider (133).

In some cases, the contemplated control panel (130) can be built in such a way that it can record memory of the times and coordinates of the sliders (and corresponding motion actuators) over a period of time, and replay that sequence of motion and positions on demand. The contemplated control panel may also be constructed so as to provides a method by which users may save, share and use different memorized sequences, starting positions and customizations to how the control panels interprets the positions of the sliders to determine the motion and target positions of the motion actuators (112-118).

In some cases, each of the multiple surfaces (102-108) can be controlled individually by the control panel, such that each of the multiple surfaces (102-108) can move independently from each other. The multiple surfaces (102-108) can be configured to move simultaneously, such that any or all of them move up at the same time, move down at the same time, or move in opposite directions at the same time. In some cases, they can move one after another in a sequential manner. The set of motion actuators (112-118) are each coupled to a stationary solid frame (120) (i.e., “chassis” structure) that rests on the floor or connects to another stationary structure.

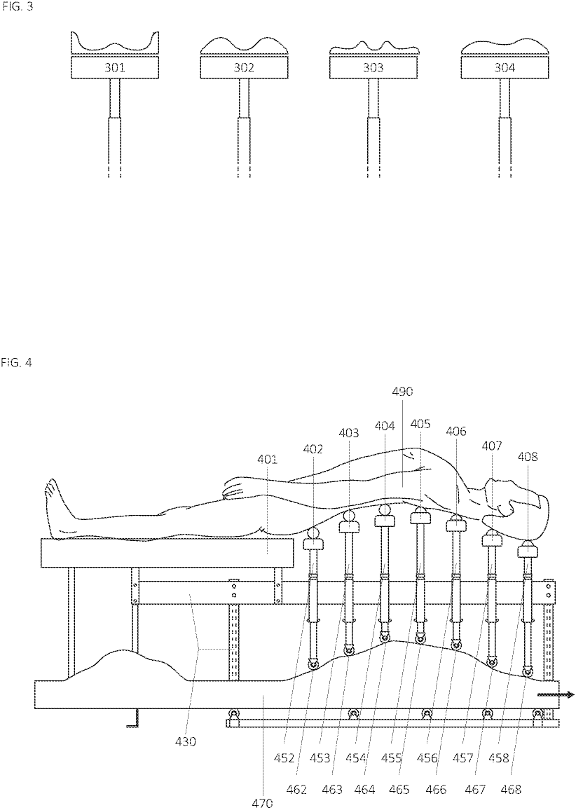

FIG. 2A shows an example of a Spine Piano having a surface configured to change shape and to change a curvature of the person’s spine. The surface has several contiguous sections (242-248). It is contemplated that two or more of those sections (242-248) are controlled individually and simultaneously by the user: to either remain in place or to move vertically up and down (rise and fall) to any chosen height within a specific range of motion. This is done while a person is lying on the Spine Piano, thus providing stretches and massages to their body. In this example, the motion actuating mechanisms comprises inflatable chambers (222-228) and a compressor (230). Two or more sections of the top surface (242-248) are resting on top of sealed chambers of air or liquid (222-228) that grow or shrink as pressure is added or removed from them, thanks to a mechanism of pumps or compressors (230) and valves (231-239).

FIG. 4 shows another example of a Spine Piano having multiple surfaces configured to move up and down vertically to change a curvature of the person’s spine. In this example, the actuating mechanism comprises using sliders rolling on a curved shape (470).

In FIG. 4, each of 2 or more of the separate sections of the top surface (402-408) are attached to their own individual “piston” sliders (452-458) that can freely move up and down with wheels at their base (462-468). A shape (470) with a straight lower edge and uneven upper edge is pulled through the space below the pistons, pushing the pistons up as their wheels roll over higher sections of the upper surface of the shape. The pistons then fall back down as they roll over lower sections of the upper surface of the shape.

FIG. 5A shows yet another example of a Spine Piano having a control panel comprising switches (512-518) each connected to their respective motion actuators (522-528). In some cases, the switches (512-518) can be electrical “actuator switches” such as joystick (510B) or thumbwheel (510C) (FIG. 5B or FIG. 5C), or other similar electrical switches that can be used to control the flow of electrical power to the motion actuators that control the movement of the multiple surfaces (502-508). For example, if a user pushes one or more switches (512-518) up or down, the corresponding motion actuators move in that same direction (up or down) until the user releases pressure on the switch, or until the moving part of the motion actuators reaches the end of its range of motion.

Optionally, the inventive subject matter may include a cover layer that is manufactured to be flexible or elastic and that rests on the top surface for customized comfort or hygiene.

To use the device, a person (190) may lie on the Spine Piano, facing up with the lower half of their body resting on the leg rest (101) and the upper half of their body resting on the one or more movable parts (102-108).

In cases where a control panel (130) is used, that person (190) may move the control sliders (131-137) to different positions and thus experience massage and stretching from the movement of the upper sections (102-108) that will move to the position defined by the control panel.

In cases where actuator switches (510B or 510C) are used, that person (190) or a second person may press any of the switches (512-518) up or down until the moveable surfaces (102-108) that those switches control are in a desired position.

In cases where sliders rolling on a curved shape (470) are used, while that person (490) is lying on the Spine Piano, another person will use a mechanism (such as a crank or winch) to pull the irregular shape (470) through the space between the wheels (462-468) so as to move the pistons (462-468) and the moveable surfaces (402-408) they are connected to, thus provided stretches and massages to the person (490) lying on top.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A device for adjusting a person’s spine, comprising,
a support configured to support the person’s spine,
wherein the support comprises at least two surfaces; and
wherein the at least two surfaces are each configured to move relative to the person’s spine to change a curvature of the person’s spine.

2. The device in claim 1, wherein the at least two surfaces are configured to change the relative positions of at least two vertebrates in the person’s spine.

3. The device in claim 1, wherein the at least two surfaces are each configured to push into at least a portion of the person’s spine.

4. The device in claim 1, wherein the at least two surfaces are each configured to move relatively perpendicular to the curvature of the person’s spine.

5. The device in claim 1, wherein the at least two surfaces are configured to move independently relative to each other.

6. The device in claim 1, wherein the at least two surfaces are configured to move simultaneously.

7. The device in claim 1, wherein the at least two surfaces are configured to move sequentially.

8. The device in claim 1, wherein the change in the curvature of the person’s spine comprising forward or backward bending of the spine.

9. The device in claim 1, further comprising at least one actuator configured to move the at least two surfaces, wherein the actuator comprises at least one of a motor, a piston, a liquid pump, an air pump, or a handle configured to be operated by a human.

10. The device in claim 1 further comprising a controller, wherein at least one surface is controlled by the controller.

11. The device in claim 1, further comprising a leg support for the person’s legs.

12. The device in claim 1, further comprising a head support for the person’s head.

13. The device in claim 1, wherein at least one surface comprises two protrusions configured to contact the left and right sides of the spine.

14. The device in claim 1, wherein at least one surface is configured to contact the person’s upper back; and at least one surface is configured to contact the person’s lower back.

15. The device in claim 1, wherein the support comprises at least three surfaces each configured to move relative to the person’s spine to change a curvature of the person’s spine.

16. The device in claim 1, wherein the support comprises at least six surfaces each configured to move relative to the person’s spine to change a curvature of the person’s spine.

17. A device for adjusting a person’s spine, comprising,
a support configured to support the person’s spine,
wherein the support comprises a surface configured to change shape and to change a curvature of the person’s spine.

18. The device in claim 17, wherein changing shape of the surface is configured to change the relative positions of at least two vertebrates in the person’s spine.

19. The device in claim 17, wherein changing shape of the surface is configured to push into at least a portion of the person’s spine.

20. The device in claim 17, wherein the change in the curvature of the person’s spine comprising forward or backward bending of the person’s spine.
